(19) United States
(12) Patent Application Publication
(10) Pub. No.: US 2025/0324472 A1
(43) Pub. Date: Oct. 16, 2025

(54) COLLABORATIVE CLOUD-BASED RADIO FREQUENCY MANAGEMENT

(71) Applicant: Shure Acquisition Holdings, Inc., Niles, IL (US)

(72) Inventors: Michael John Benonis, Chicago, IL (US); Michael Charles Unruh, Fishers, IN (US)

(73) Assignee: Shure Acquisition Holdings, Inc., Niles, IL (US)

(21) Appl. No.: 19/053,756

(22) Filed: Feb. 14, 2025

Related U.S. Application Data
(60) Provisional application No. 63/632,511, filed on Apr. 10, 2024.

(51) Int. Cl. H04W 76/15; G06K 19/06; H04W 48/16; H04W 72/0453

(52) U.S. Cl. CPC H04W 76/15; H04W 48/16; H04W 72/0453; G06K 19/06037

(57) ABSTRACT

Aspects of the disclosure relate to radio frequency (RF) spectrum coordination using a cloud-based coordination system. Users may interface with the cloud-based coordination system by scanning a machine-readable code, such as a QR code. The scanning of the code may initiate communication between a user device and the coordination system, and allow for the determination of available frequencies at a particular location or venue and the reservation of one or more frequencies for use by audio devices associated with the user. The audio devices may be configured offline in the event the location or venue has no internet access.

### CROSS REFERENCE TO RELATED APPLICATIONS

This patent application claims priority to, and the benefit of, U.S. Provisional Patent Application No. 63/632,511, filed Apr. 10, 2024, entitled “Collaborative Radio Frequency Management,” which is incorporated herein by reference in its entirety.

### TECHNICAL FIELD

Aspects of the disclosure relate to radio frequency management and more specifically to collaborative, cloud-based radio frequency management for improved radio frequency performance.

### BACKGROUND

Wireless audio equipment (WAE), including wireless microphones (WM) and wireless in-ear monitoring (WIEM) devices, use available radio frequency (RF) spectrum to operate and may use analog or digital narrowband modulation techniques, for example. The availability may be limited based on location, time and date of use, and/or other (e.g., environmental and/or regulatory) factors. The availability of radio spectrum may be further limited at locations (e.g., venues) with multiple different WAE systems. For example, RF spectrum availability at a given location (e.g., venue) is unique, and may be based on: government regulation(s); permanent wireless equipment installed in and around the venue, such as television stations, mobile phone equipment, and other devices; itinerant wireless equipment operated by the venue and various entities in and around the venue, including nearby similar but separate venues; and/or one or more other factors. The limited RF spectrum availability may result in undesired interactions between the WAE systems, resulting in decreased performance.

### SUMMARY

The following summary presents a simplified summary of certain features. The summary is not an extensive overview and is not intended to identify key or critical elements. Aspects of the disclosure provide improved, scalable, and reliable technical solutions that address and overcome the problems associated with operation of WAE systems, including in deployments with limited RF spectrum availability.

For improved performance at locations with limited RF spectrum availability, communication systems, including one or more WAE systems (e.g., single-carrier systems), may use frequency coordination (FC) to reduce the likelihood of interference. Interference may occur from various Intermodulation (IM) products generated by the nonlinear mixing of two or more narrowband signals and/or as Adjacent Channel Interference (ACI) from closely-spaced narrowband carriers which cannot be fully rejected by the receiver. Such system may use computer software and/or databases (e.g., look-up tables) storing predetermined compatible radio frequencies to coordinate RF spectrum deployment for WAE systems. The coordination of the RF spectrum deployment may address the itinerant nature of WAE systems (e.g., the systems may be owned by a venue or by one or more unrelated performers) and the variable skill level of the equipment operators. The WAE systems adapted for RF spectrum coordination may configure WAE of the WAE systems at a particular location, including determining the RF spectrum to be used by the WAE of the WAE system(s). The coordination may be time-based and/or location-based, and allow the WAE systems to preconfigure the RF spectrum settings, including reserving RF spectrum for desired period of time(s) and/or location(s) for specific user(s).

The WAE systems may provide collaborative radio frequency management for one or more performance venues (or other locations) to address realized or potential interactions between WAE systems using the RF spectrum at the location so as to reduce or avoid undesirable interactions or conflicts between various WAE and/or other wireless device(s). Aspects of the disclosure advantageously encourage and assist users with RF spectrum coordination, including less sophisticated users that may not appreciate the usefulness of spectrum coordination and/or lack the knowledge to perform such coordination. In one or more aspects, the WAE system may use cloud-based collaborative management. For example, the WAE system may be configured as an information management system, such as a cloud-based system, which may provide collaboration between various users for RF spectrum (e.g., one or more frequencies and/or frequency ranges) coordination and/or the coordination of one or more other operating parameters and/or configurations of the WAE. The RF spectrum frequency coordination at a given location may be based on one or more user interactions or requests. The user(s) may interact with the WAE system using one or more computer-readable codes or labels (e.g., quick response (QR) codes, bar codes, or other labels); a wirelessly readable tag (e.g., near-field communication (NFC) tag, Bluetooth tag, Radio Frequency Identification (RFID) tag, and/or other wirelessly-readable tags), universal resource locators (URL), cloud services, location services of the user's mobile and/or audio devices, and/or other manual or automated interaction with the WAE system's user interface and/or other input/output interfaces.

The collaborative radio frequency management may be configured to facilitate the sharing of RF spectrum at a given location, including allowed and/or available RF spectrum; maintain historical RF spectrum information, including availability history, performance history, audio and/or user device history, and/or use history at one or more locations; RF spectrum configurations for one or more devices; other user information and/or device information; and/or collected analytic and/or usage information.

These and other features and advantages are described in greater detail below.

### BRIEF DESCRIPTION OF THE DRAWINGS

The present disclosure is illustrated by way of example and not limited in the accompanying figures in which like reference numerals indicate similar elements and in which:

FIG. 1 shows an example Wireless audio equipment (WAE) system according to one or more aspects of the disclosure.

FIG. 2 shows an example WAE system according to one or more aspects of the disclosure.

FIG. 3 shows an example architecture of a computing device according to one or more aspects of the disclosure.

FIGS. 4A-4E illustrate a workflow of a method for radio frequency coordination according to one or more aspects of the disclosure.

FIGS. 5A-5B illustrate a workflow of a method for radio frequency coordination according to one or more aspects of the disclosure.

FIGS. 6A-6E illustrate a workflow of a method for radio frequency coordination according to one or more aspects of the disclosure.

FIG. 7 shows an example radio frequency coordination application executed by a computing device according to one or more aspects of the disclosure.

FIG. 8 shows an example radio frequency coordination application executed by a computing device according to one or more aspects of the disclosure.

FIG. 9 shows an example venue with various wireless devices using available RF spectrum according to one or more aspects of the disclosure.

FIG. 10 is a flowchart of a method for radio frequency coordination according to one or more aspects of the disclosure.

FIG. 11 is a flowchart of a method for radio frequency coordination according to one or more aspects of the disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure. It is noted that various connections between elements are discussed in the following description. It is noted that these connections are general and, unless specified otherwise, may be direct or indirect, wired or wireless, and that the specification is not intended to be limiting in this respect.

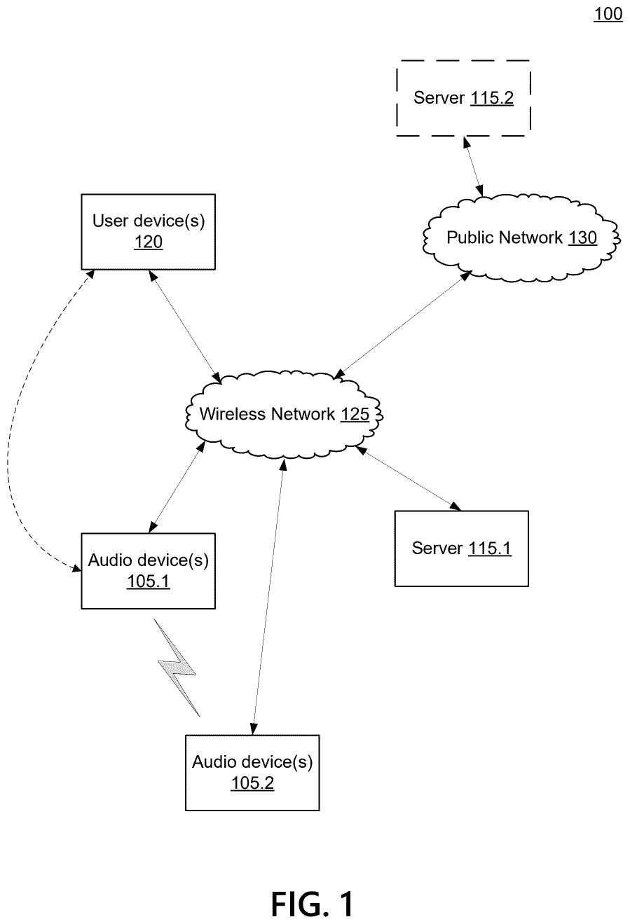

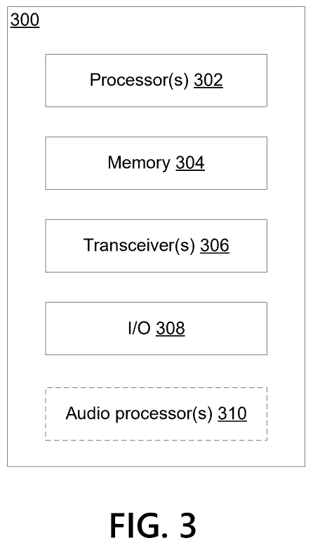

FIG. 1 shows an example Wireless audio equipment (WAE) system 100. The WAE system 100 may comprise one or more audio devices 105 (e.g. WAE), one or more frequency coordination servers 115, one or more user devices 120, and/or one or more other devices connected via a wireless network 125. One or more of the devices of the WAE system 100 may be used to implement one or more illustrative aspects discussed herein. For example, the audio device(s) 105, frequency coordination server(s) 115, and/or user device(s) 120 may, in some aspects, implement one or more aspects of the disclosure by reading and/or executing instructions and performing one or more actions based on the instructions. In some aspects, the audio device(s) 105, frequency coordination server(s) 115, and/or user device(s) 120 may represent, be incorporated in, and/or include various computing and/or data processing devices, such as computing device 300 of FIG. 3.

The wireless network 125 may facilitate communication of data and/or control information between the various devices connected to the wireless network 125. One or more of the devices with the system 100 may additionally or alternatively communicate directly (e.g., not via the wireless network 125) with one or more other devices. For example, an audio device 105.1 (e.g., wireless microphone) may communicate directly with another audio device 105.2 (e.g., audio receiver) using, for example, one or more frequencies and/or frequency ranges of available RF spectrum. Additionally, or alternatively, one or user devices 120 may communicate directly with one or more audio devices 105. The direct and/or indirect communications between two or more devices of the WAE system 100 may use one or more frequencies and/or frequency ranges of available RF spectrum. The WAE system 100 may be adapted to facilitate the communication of data and/or control information between devices by coordinating the RF spectrum used by the various devices and/or locations.

One or more devices in the wireless network 125 may also be configured for communication via a public network 130 (e.g., the Internet). Connection to the public network 130 may enable one or more devices, associated with the wireless network 125, to communicate with a server, such as radio frequency coordination server 115, to transmit and/or receive frequency coordination information to/from the server 115. Additionally, or alternatively, connection to the public network 130 may enable one or more devices, associated with the wireless network 125, to communicate with the frequency coordination server 115 and/or one or more servers, to receive device configuration information from the server(s) (e.g., software and/or firmware updates), to live-stream audio data to remote listeners, and/or to receive audio data (e.g., broadcast from a remote location, from a server, etc.) for playback via the audio device(s) 105, etc. Communication via the wireless network 125 and/or the public network 130 may comprise transmission and/or reception of electrical and/or electromagnetic signals that may comprise data (e.g., audio data, or any other type of data) and/or control information.

The devices in the WAE system 100 may transmit, receive, and/or otherwise exchange or share information via hardware and/or software interfaces using one or more communication protocols (e.g., proprietary and/or non-proprietary communication protocols). The communication protocols may define/codify operation of one or more layers in an Open Systems Interconnection (OSI) model that enable interconnection between and interoperability of multiple devices, applications, and/or systems forming the WAE system 100. For example, devices in connected via the wireless network 125 may use one or more of Bluetooth protocol(s), Zigbee protocol(s), near-field communication (NFC) protocol(s), Radio Frequency Identification (RFID) protocol(s), Institution of Electrical and Electronics Engineers (IEEE) 802.11 Wi-Fi protocol(s), 3^{rd} Generation Partnership Project (3GPP) cellular protocol(s), local area network (LAN) protocol(s), hypertext transfer protocols (HTTP), and/or any other wireless communication protocol, to send and receive audio and/or control information. At least some devices in the wireless network 125 may (e.g., additionally) use wired communication protocols (e.g., universal serial bus (USB) protocol(s), Ethernet protocol(s), and/or any other wired communication protocol).

In an example, the communication between the devices in the WAE system 100 may be via wireless channels that are designated as industrial, scientific, and medical (ISM) bands defined by the International Telecommunication Union (ITU) Radio Regulations (e.g., a 2.4 GHz-2.5 GHz band, a 5.75 GHz-5.875 GHz band, a 24 GHz-24.25 GHz band, and/or a 61 GHz-61.5 GHz band, etc.). Additionally, or alternatively, the communication between the devices in the WAE system 100 may be via (e.g., one or more channels within) a very high frequency (VHF) band (e.g., 30 MHz-300 MHz band) and/or via (e.g., one or more channels within) an ultra-high frequency (UHF) band (e.g., 300 MHz-3 GHZ).

Transmission of audio data may use one or more frequencies and/or frequency ranges of available RF spectrum, and may comprise conversion of analog audio data into digital audio data, packetization of the digital audio data, and transmission of audio packets via a communication channel. Reception and processing of audio packets may comprise demodulation of received signals to retrieve the digital audio data and/or conversion of digital audio into analog signals. A combination of audio codecs and communication protocols may specify the generation, transmission, reception, and processing of audio data.

The data transferred to and/or from various devices may include secure and sensitive data, such as confidential documents, user personally identifiable information, and account data. Therefore, it may be desirable to protect transmissions of such data using secure network protocols and encryption, and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many aspects, one or more web services may be implemented within the various computing devices. Web services may be accessed by authorized external devices and users to support input, extraction, and manipulation of data between the various computing devices in the system 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls. Such specialized hardware may be installed and configured in the system 100 in front of one or more computing devices such that any external devices may communicate directly with the specialized hardware.

Audio device(s) 105 may comprise one or more audio input device(s), audio output device(s), and/or audio processing device(s). Audio device(s) 105 may comprise one or more of: microphone(s), microphone ear piece(s), transceiver(s) (e.g., associated with a musical instrument), speaker(s), wireless headset(s), audio receiver device(s) (e.g., with an output interface such as an XLR connector, USB connector, 3.5 mm connector, etc.), audio mixer(s), and/or any other type of device capable of generating and/or processing audio data. The audio device(s) 105 may interface and/or consolidate communications between one or more other audio devices 105. For example, an audio device 105 may receive audio data (e.g., packets) from audio input device(s) (e.g., microphone(s)), and may send (e.g., unicast, broadcast) audio data (e.g., packets) to audio output device(s) (e.g., speaker(s), earpieces associated with microphones) and/or audio processing device(s) (e.g., a sound mixer). The audio device(s) 105 may include and/or be implemented with one or more other audio subcomponents to form an audio system that includes a chain of discrete subcomponents, each of which may be configured to perform a specific audio processing functionality. For example, the subcomponents may include microphones, receivers, mixers, amplifiers, speakers, musical instruments, general-purpose computing devices, etc.

As an example, an audio system may receive audio from one or more microphones and/or instruments, and process the audio via a receiver, a mixer, and/or amplifier(s), prior to outputting the audio via one or more speakers. Various examples herein describe a personal stage monitoring (PSM) system, or an audio system comprising a PSM system, that may be connected to one or more other audio devices (e.g., microphones, speakers, musical instruments and/or instrument outputs, transmitters, receivers, transceivers, computing devices, etc.). The PSM system may be flexibly configured to receive audio input from one or more audio sources (e.g. microphone(s), instrument(s), and/or audio track(s)) and provide monitoring feedback to the performer.

The user device(s) 120 may comprise one or more personal computing device(s) (e.g., desktop computers, laptop computers), mobile computing device(s) (e.g., smartphone(s), tablet(s)), and/or any other device that may provide a user interface (e.g., graphical user interface (GUI)) for controlling and monitoring the operation of the audio device(s) 105, server(s) 115, and/or other device(s) of the communication network; and/or communicating and/or interfacing with the audio device(s) 115, server(s) 115 and/or other device(s) of the communication network, such as one or more other devices associated with other users participating in the RF coordination. For example, the user device 120 may be used to provide and/or adjust various settings and/or operational parameters of the audio device(s) 105 and/or any other device in the system 100.

The user device(s) 120 may be configured to interface with (e.g., using a user interface) the radio frequency coordination server 115 to exchange frequency coordination information (e.g., available RF spectrum at one or more locations (e.g., venues)), select and/or reserve RF spectrum (e.g., one or more frequencies and/or frequency ranges) for use by one or more audio devices 105 associated with the user of the user device 120. The reservation of RF spectrum may be associated with a time duration, date, location, and/or other parameter(s). The reservation of the RF spectrum may be stored as coordination information by the radio frequency coordination server(s) 115, audio device(s) 105, and/or user device(s) 120. The frequency coordination information may be stored in two or more devices in a distributed and/or duplicative manner. Additionally, or alternatively, the user device(s) 120 may be configured to add, remove, and/or modify user account information for one or more radio frequency coordination applications (e.g., wireless workbench (WWB)); add, remove, and/or modify one or more audio devices 105 associated with the user to the user's account for the radio frequency coordination application(s); and/or otherwise interface with the radio frequency coordination application(s).

The radio frequency coordination server 115 may host or otherwise include one or more databases storing data, such as frequency coordination information and/or other data. The coordination information may include RF spectrum information such as one or more frequencies and/or frequency ranges. The frequencies and/or frequencies ranges may be correlated with other information, such as: venue information for one or more venues; status information indicating whether the frequencies and/or frequencies ranges are available, assigned to one or more users and/or devices, and/or reserved by one or more users and/or devices; temporal information (e.g., time, date, etc. information associated with the status of the frequencies); user information (e.g., user identification information); user device information of one or more user devices 120; audio device information of one or more audio devices 105; and/or network information for one or more networks (e.g., network 125, PAN 225). Databases may include, but are not limited to relational databases, non-relational databases, hierarchical databases, distributed databases, in-memory databases, flat file databases, XML databases, NoSQL databases, graph databases, and/or a combination thereof. The server 115 may be embodied as a local server (e.g., server 115.1) and/or a remote server (e.g., server 115.2), such as a cloud server configured to execute one or more cloud-based application to perform aspect(s) of the disclosure. The cloud-based applications may be one or more “serverless” applications, such as Lambda functions.

Additionally, or alternatively, the radio frequency coordination server 115 may store account data associated with one or more users; device data associated with one or more user devices 120 and/or audio devices 105; temporal data (e.g., time duration, date); location data (e.g., of device(s), venues, etc.); historical data, such as historical RF spectrum information, historical frequency availability information, performance history (e.g., of one or more users), audio and/or user device history (e.g., use history at one or more locations); user information (e.g. user account data); device information; analytic and/or usage information; application data, such as data associated with radio frequency coordination applications (e.g., wireless workbench (WWB)); and/or other data and/or applications. Any of the data and/or information stored in the radio frequency coordination server 115 may be stored in two or more devices (e.g., in two or more servers 115) in a distributed and/or duplicative manner.

The radio frequency coordination server 115 may be configured to select and/or reserve RF spectrum (e.g., one or more frequencies and/or frequency ranges) for use by one or more audio devices 105 associated with the user device 120. The reservation of RF spectrum may be associated with temporal information (e.g., time duration, date), one or more locations, and/or other parameter(s). The reservation of the RF spectrum may be stored as the frequency coordination information by the radio frequency coordination server(s) 115, audio device(s) 105, and/or user device(s) 120. Additionally, or alternatively, the radio frequency coordination server 115 may be configured to host one or more radio frequency coordination applications (e.g., wireless workbench (WWB)). The radio frequency coordination application(s) may be downloadable from the radio frequency coordination server 115 by the user device(s) 120, audio device(s) 105, and/or other devices. The radio frequency coordination application(s) may be installed by one or more devices, such as the user device 120 and/or audio device(s) 105. The radio frequency coordination application(s) may be adapted to facilitate the coordination of the RF spectrum according to one or more aspects of the disclosure, including the example workflows discussed below.

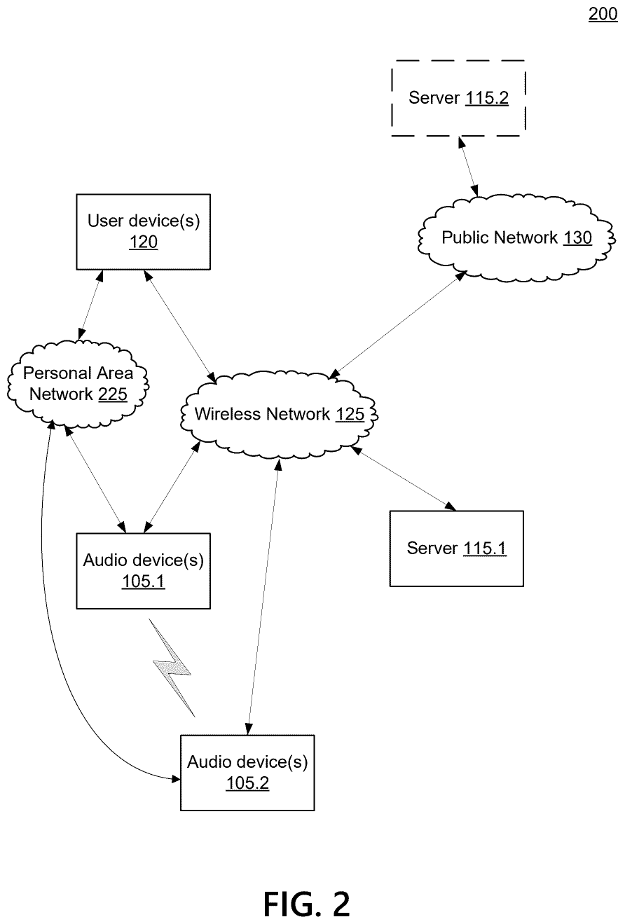

FIG. 2 shows an example WAE system 200, which is similar to the WAE system 100. Like WAE system 100, the WAE system 200 may comprise one or more audio devices 105, one or more frequency coordination servers 115, one or more user devices 120, and/or one or more other devices connected via a wireless network 125. The wireless network 125 may facilitate communication of data and/or control information between the various devices connected to the wireless network 125. Additionally, the WAE system 200 may include one or more personal area networks (PAN) 225 established between two or more devices. The PAN 225 may facilitate communication of data and/or control information between the various devices connected to the PAN 225. For example, the PAN 225 may be established between the user device(s) 120 and one or more audio devices 105 to facilitate communication of data and/or information, such as frequency coordination information, audio device configuration and/or operational information (e.g., one or more settings and or parameters of the audio device), other data, and/or control information between the user device(s) 120 and the audio device(s) 105. In this example, the PAN 225 may be established by the user device(s) 120 and/or the audio device(s) 105. The devices may communication via the PAN 225 using one or more communication protocols as discussed herein. In one or more aspects, the communications protocols of the PAN 225 include low-powered, short-distance protocols (e.g., Bluetooth, NFC, Zigbee, etc.).

FIG. 3 shows an example of a computing device 300 that may be used to implement one or more illustrative aspects discussed herein. For example, the computing device 300 may, in some aspects, implement one or more aspects of the disclosure by reading and/or executing instructions and performing one or more actions based on the instructions. In some aspects, the computing device 300 may represent, be incorporated in, and/or include various devices such as a server 115, user device 120, audio device 105, and/or any other type of data processing device.

The computing device 300 may include one or more of processor(s) 302, memory 304, transceiver(s) 306, and/or input/output (I/O) interface(s) 308. One or more data buses may interconnect the processor(s) 302, the memory 304, transceiver(s) 306, and/or I/O interface(s) 308. The computing device 300 may be implemented using one or more integrated circuits (ICs), software, or a combination thereof, configured to operate as described herein. The memory 304 may comprise any memory, such as a random-access memory (RAM), a read-only memory (ROM), a flash memory, or any other electronically readable memory, or the like. The memory 304 may include one or more memory units.

Signals transmitted from and/or received by the computing device 300 may be encoded in one or more data units. For example, the processor(s) 302 may be configured to generate data units, and process received data units, that conform to any suitable wired and/or wireless communication protocol. The processor(s) 302 may be configured to execute machine readable instructions stored in memory 304 to perform one or more operations described herein. The transceiver 306 may be configured to send/receive signals using RF one or more communication protocols. The communication protocols may be any wired communication protocol(s), wireless communication protocol(s) using available RF spectrum, and/or one or more protocols corresponding to one or more layers in the Open Systems Interconnection (OSI) model (e.g., a LAN protocol, an IEEE 802.11 WIFI protocol, a 3GPP cellular protocol, an HTTP, a Bluetooth protocol, etc.).

Processor(s) 302 may include one or more computer processing units (CPUs), graphical processing units (GPUs), and/or other processing units such as a processor adapted to perform computations associated with data processing, audio processing, image processing, communication processing, database operations, etc.

Memory 304 may store software for configuring computing device 300 into a special purpose computing device in order to perform one or more of the various functions discussed herein. Memory 304 may store operating system software for controlling overall operation of the computing device 300, control logic for instructing the computing device 300 to perform aspects discussed herein, database creation and manipulation software, radio frequency coordination applications (e.g., wireless workbench (WWB)), and other applications.

The I/O interface 308 may be configured to receive one or more inputs that allow the computing device 300 to receive audio signals from different sources, such as microphones, instruments, and playback devices. The audio signals may be received on one or more channels. The I/O interface 308 may include one or more input connections configured to receive input data and/or signals using one or more wired and/or wireless communication protocols, and/or may include one or more input devices (e.g. keyboard, control panel, graphical user interface (GUI), human-machine interface, or the like). Additionally, or alternatively, the I/O interface 308 may include one or more output connections configured to transmit output data and/or signals using one or more wired and/or wireless communication protocols, and/or may include one or more output devices (e.g. speaker, display, GUI, etc.). The I/O interface 308 may include a dedicated audio interface (e.g., 3.5 mm connector), a general-purpose interface (e.g., a universal serial bus (USB) connector), an XLR connector, or any other type of interface.

Inputs to the computing device 300 (e.g. via the I/O interface 308) may be any audio, electrical, and/or electromagnetic signals (e.g., originated from any input devices and/or sources, such as from the performer(s), instrument(s), audio track(s), etc.) that may be processed by the computing device 300. Outputs from the computing device 300 may be any audio, electrical, and/or electromagnetic signals that may be played back via output devices, stored, and/or processed by other devices. Input devices that may provide input to the computing device 300 may comprise one or more of: wireless microphones, wearable packs (e.g., beltpacks) associated with microphones, wireless headsets integrated with a microphone, electronically-readable memory comprising stored audio, a computing device (e.g., smartphone, tablet) with integrated microphones, and/or a transceiver associated with a musical instrument. Output devices that may be connected to the computing device 300, and receive output from the computing device 300, may include one or more of: speakers, wearable packs (e.g., beltpacks) associated with headsets, a wireless headset, a user computing device, an electronically-readable memory, a transceiver associated with a musical instrument, an output interface (e.g., an XLR connector, USB connector, 3.5 mm connector, etc.), a server associated with a computing network (e.g., local network, public network such as the Internet), a computing device (e.g., smartphone, tablet) with integrated speakers or connected headphones, etc.

In one or more aspects, the computing device may include audio processor 310 configured to perform one or more audio processing operations, audio mixing operations, digital signal processing (DSP), and/or other signal processing on the audio signals received (e.g. via I/O interface 308) to generate processed audio data. The processing operations may be performed in the analog or digital domains. If multiple processing operations are performed, one or more operations may be performed in the analog domain while one or more other operations may be performed in the digital domain.

The processor 302 and/or audio processor 310 may be configured to perform one or more processing operations using machine learning (ML), such as using one or more ML models to adjust (e.g. optimize) parameters to control the processing operations (e.g., audio processing of the audio processor 310). The ML model may support a generative adversarial network, a bidirectional generative adversarial network, an adversarial autoencoder, or an equivalent thereof. Additionally, or alternatively, the ML model may be a convolutional neural network, a recurrent neural network, a recursive neural network, a long short-term memory (LSTM), a gated recurrent unit (GRU), an unsupervised pretrained network, a space invariant artificial neural network, or any equivalent thereof. The ML model may be trained based on input data and/or output data of the computing device 300, one or more other components of the WAE system, and/or one or more other devices in communication with the WAE system. The ML model may be trained using different training techniques, such as supervised training, unsupervised training, semi-supervised training back propagation, transfer learning, stochastic gradient descent, learning rate decay, dropout, max pooling, batch normalization, and/or any equivalent deep learning technique.

The audio processing operations may include the adjustment of audio levels, panning, equalization (EQ), dynamic EQ, compression, multiband compression, summing, filtering, noise reduction, reverb, gain, delay, gating, expansion, de-essing, ducking, saturation, harmonic distortion, one or more modulation effects, sidechaining, adjustments to one or more other audio parameters, and/or one or more other audio processing operations.

Panning may include the process of placing audio elements in the stereo field, so that they appear to come from a particular location in the audio spectrum. For example, by adjusting the left-right balance of a signal, panning may create a sense of space and dimensionality in a mix. Equalization (EQ) may include the process of adjusting the frequency balance of audio tracks to improve balance and/or clarity. Equalization may include cutting or boosting specific frequency ranges to remove unwanted frequencies or enhance desired ones, and/or may be used to achieve a desired tone or timbre. Dynamic EQ may include adjusting the gain of certain frequency bands based on the input level of the audio signal, and may be useful in controlling harsh frequencies or taming certain resonances. Compression may include the process of reducing the dynamic range of audio tracks, making loud sounds quieter and quiet sounds louder. By reducing the difference between the loudest and softest parts of a track, compression may provide a more consistent and controlled audio. Multiband Compression is similar to compression, but instead of applying a single level reduction to the entire audio signal, it applies different levels of compression to different frequency bands. Multiband compression may be used to balance out a mix that has a lot of frequency imbalances. Summing may include adding together two or more audio signals to create a single output signal. The summing of audio signals may preserve the relative volume levels and stereo placement. Filtering may include the process of removing or attenuating certain frequencies in an audio signal, and may be used to remove unwanted noise and/or resonances, and/or to shape the tone of an audio signal. Noise reduction may include removing unwanted noise from an audio signal, such as removing hiss, hum, and/or other types of noise that may degrade the audio quality. Reverb may include simulating an acoustic environment in which an audio signal was recorded, and may be used to add space, depth, and/or natural reverberation to an audio signal, and/or to create a sense of continuity between different parts of a mix. Gain may include adjusting the overall level of an audio signal, and may be used to balance levels of different audio tracks in a mix, and/or to increase or decrease the overall loudness of the audio track. Delay adjustments may include the introduction of a time delay between an audio signal and its output, and/or the introduction of echoes and/or repeats. Delay may be used to create stereo width and/or to create rhythmic effects. Gating may include the attenuating of an audio signal when it falls below a certain level, and may be used to remove unwanted noise and/or in controlling the decay of certain sounds. Expansion may be the opposite of compression, where instead of reducing the dynamic range of an audio signal, expansion increases it. Expansion may be used to increase the life and energy to a mix. De-essing may include the process of reducing the level of harsh sibilant sounds in an audio signal, such as “s” and “t” sounds. De-essing may make a mix sound less harsh and more pleasant to listen to. Ducking may include the reduction of the level of one audio signal when another audio signal is present. This can be useful in making a mix sound more cohesive and reducing clashes between different tracks. Saturation may include adding harmonic distortion to an audio signal, which may be used add warmth and character to a mix. Harmonic Distortion may include adding distortion to an audio signal to create new harmonic content. Modulation Effects may include effects (e.g. chorus, flanger, and phaser) that modulate certain aspects of an audio signal, such as pitch, frequency, and/or amplitude. Side chaining may include using the level of one or more audio signals to control the processing of one or more other audio signals. A side chain input may be used, for example, on a compressor or other processor, which allows the level of the separate audio signal(s) to control the amount of processing applied to the other audio signal(s). For example, in a music mix, a side chain input can be used to trigger a compressor on a bass track using the kick drum track as the side chain input. This may cause the bass to be compressed every time the kick drum hits, which can help to create a more cohesive and tight rhythm section. In another example, side chaining may be used in other applications, such as where a music track can be automatically ducked (e.g. reduced in volume) whenever the voiceover is present to ensure that the voiceover remains clear and audible over the music.

In one or more exemplary embodiments, the audio processing operations may additionally or alternatively include one or more advanced processing algorithms, such as one or more audio processing that uses machine learning (ML) to adjust processing parameters and/or control the processing operations of the audio processor 310. The advanced processing techniques may include spatialization, denoising, auto mixing, and/or one or more other advanced audio processing operations. Spatialization may create a sense of space and depth within an audio mix by, for example, placing different sounds in different locations within the stereo or surround sound field, creating a more immersive and realistic listening experience. Spatialization techniques may include panning, reverberation, and delay effects, as well as more advanced techniques like binaural and ambisonic processing. Denoising may include removing unwanted noise from an audio signal (e.g. drum bleed). Noise can come from a variety of sources, including background hum, hiss, or electronic interference. Denoising techniques may include spectral subtraction, noise gating, and/or adaptive filtering, as well as more advanced techniques like ML-based noise reduction algorithms. Denoising techniques may remove and/or attenuate unwanted noise while preserving the quality and clarity of the desired audio signal. Auto mixing may include one or more mixing operations that are at least partially automated (e.g. using ML). Auto mixing may include performing one or more audio processing operations to, for example, emphasize or deemphasize one or more channels.

Other devices in the WAE system 100/200 (e.g., mixers, amplifiers, speakers, musical instruments, general-purpose computing devices, etc.) may have an architecture similar to the computing device 300. For example, one or more of the other devices in the WAE system may comprise corresponding memories, processors, transceivers, and/or I/O interfaces. In an exemplary embodiment, one or more components of the computing device 300 may include processing circuitry (e.g. one or more processors and/or circuitry) that is configured to perform the respective functions and/or operations of the component(s).

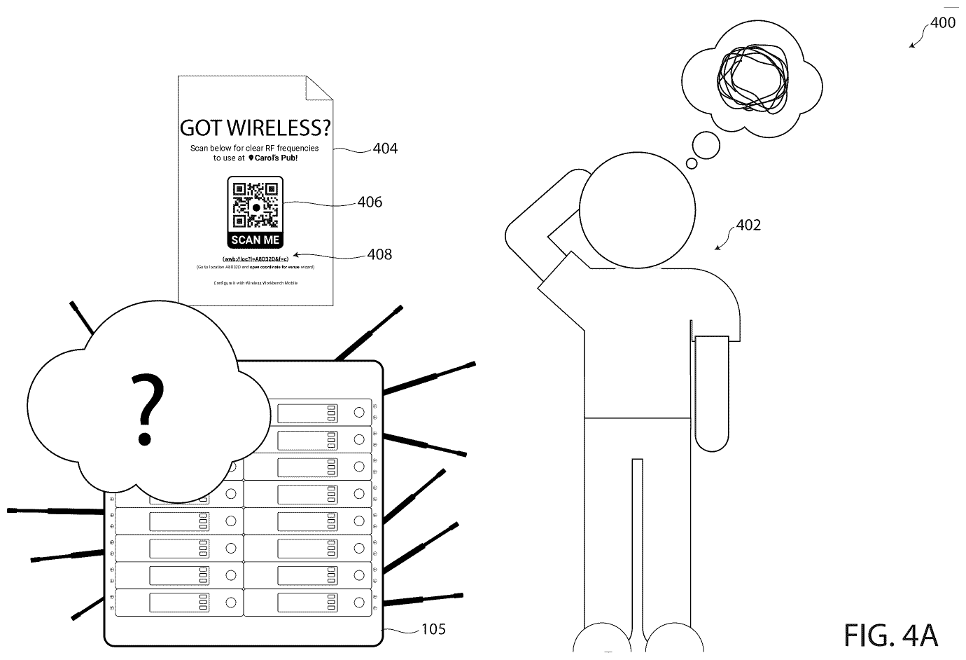

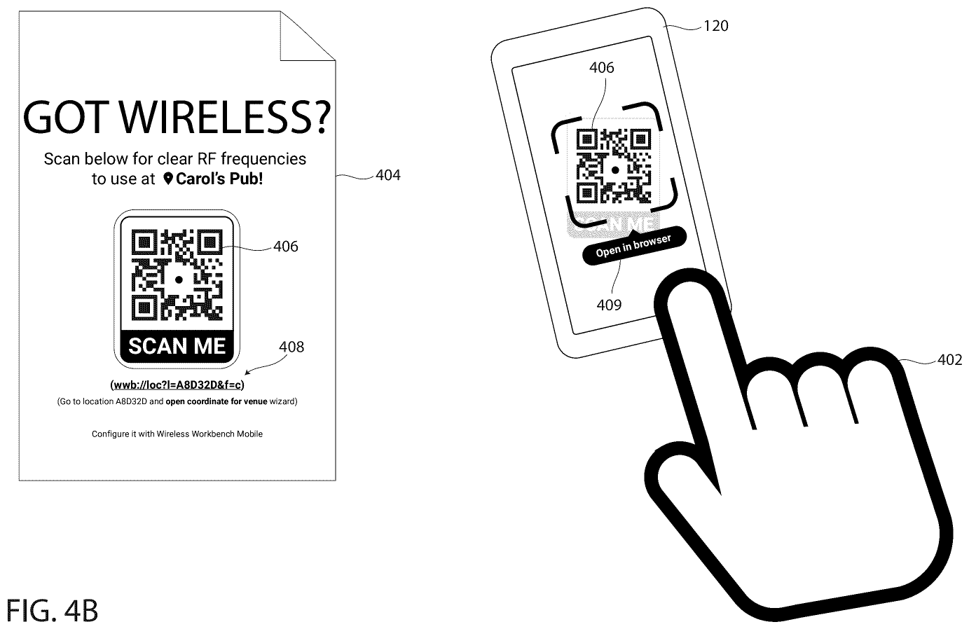

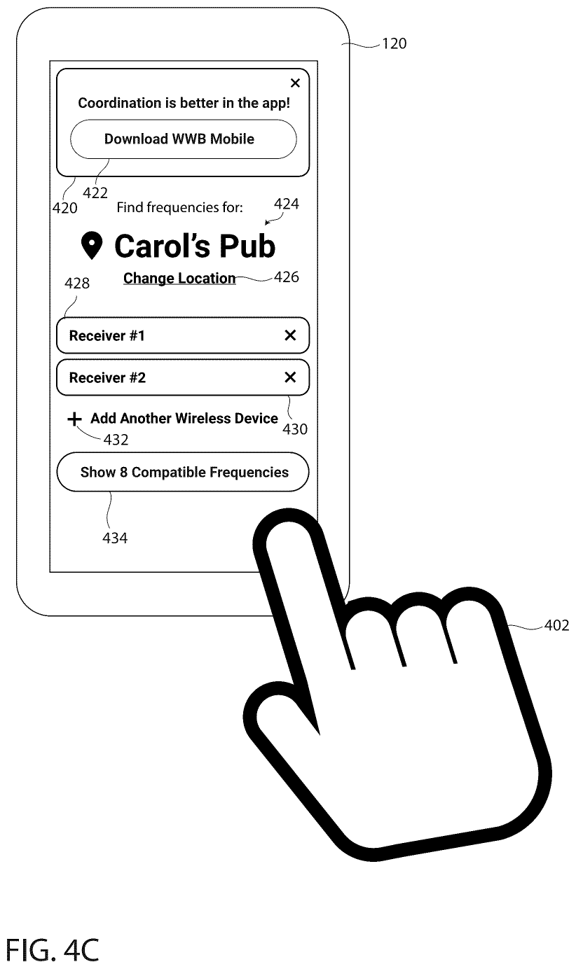

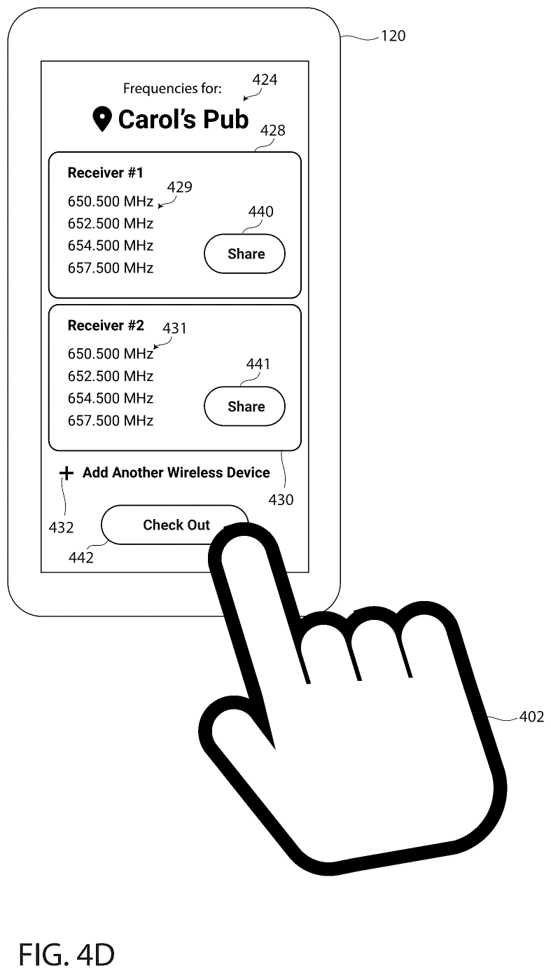

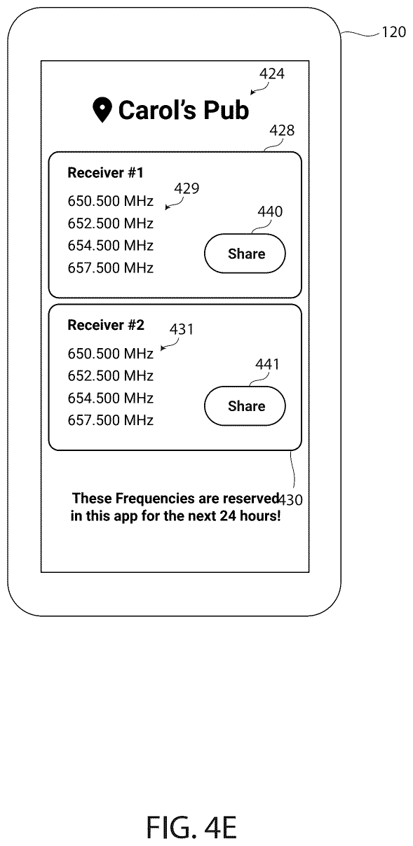

Example radio frequency coordination according to aspects of the disclosure are discussed below with reference to FIGS. 4A-4E, 5A-5B, 6A-6E, and 7. The radio frequency coordination may be implemented using the device(s) of WAE systems 100, 200 and/or computing device 300.

FIGS. 4A-4E illustrate a workflow 400 of a method for radio frequency coordination according to one or more aspects of the disclosure. FIG. 4A shows a user 402 at a venue. The user 402 may have one or more audio devices 105 that they may want to deploy at the venue, but the user 402 may be unaware of the available RF spectrum at the venue. Additionally, or alternatively, the user 402 may not appreciate the potential negative impacts that may result from spectrum conflicts, and that coordination of RF spectrum at the venue may avoid or reduce such impacts. To facilitate the coordination of the RF spectrum available at the venue, the venue may include an informational poster or sign 404 that includes information regarding the available RF spectrum and/or instructions to assist the user 402 (including users that may not appreciate that other spectrum is being used at the venue and/or that it is beneficial to coordination spectrum use with other users and/or venue deployments) in obtaining information regarding the available RF spectrum. That is, aspects of the disclosure advantageously provide techniques to not only assist more sophisticated users in coordination's spectrum, but also notify less sophisticated or experienced users about coordinating RF spectrum use (e.g. upon their arrival at the venue and after encountering the poster 404) and assist such users in facilitating the RF spectrum coordination. For example, a television news crew may arrive at a venue and intend to deploy equipment that will use RF spectrum without first consulting the venue's electronics department. In such a scenario, the news crew's RF spectrum use may conflict with RF spectrum of other users at the venue and/or the venue's own deployed equipment. However, aspects of the disclosure encourage users, such as the news crew, to coordinate the RF spectrum use, which advantageously reduces negative impacts that may result from spectrum conflicts.

The poster 404 may include one or more computer-readable codes or labels (e.g., quick response (QR) codes, bar codes, or other scannable or readable coded images, etc.) and/or universal resource locators (URL) 408, with instructions for the user 402 to interact with the QR code 406 and/or access the URL 408 to obtain further information to assist in the radio frequency coordination. Alternatively, or additionally, the poster 404 may include one or more near-field communication (NFC) tags, Bluetooth tag, RFID tags, or other wireless communications-based tags.

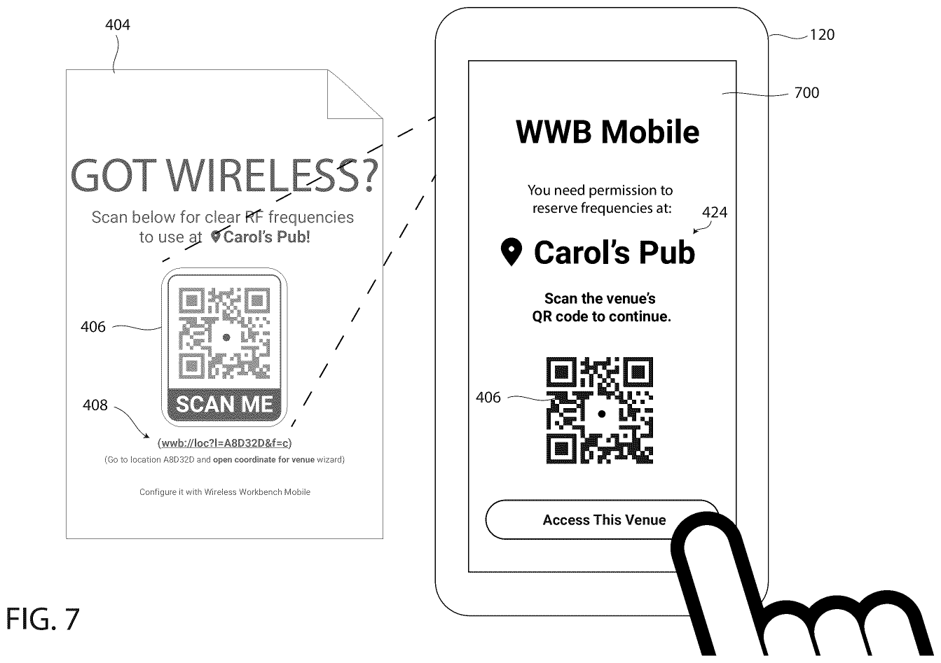

As shown in FIG. 4B, the user 402 may scan the QR using the camera of their user device 120. The user device 120 may provide a navigation button 409 in response to the scanning of the QR code 406 that launches a web browsing application on the user device 120 when pressed by the user 402. The instruction(s) embedded in the QR code may cause the web browsing application (e.g., web browser) to access a RF spectrum coordination interface of a WAE system, such as WAE system 100/200 according to the disclosure. In this example, the RF spectrum coordination interface may be a website providing a cloud-based wireless workbench application as shown in FIG. 4C, or may launch a wireless workbench mobile application installed on the user device 120. FIG. 7 illustrates an example of wireless workbench mobile application 700 that may be additionally or alternatively installed on the user device 120. In this example, the wireless workbench mobile application 700 may prompt the user 402 to access the RF spectrum coordination interface by selecting element 702.

The user 402 may have a user account associated with the user 402 that includes user account information, such as audio devices 428, 430 associated with the user 402 (e.g., “receiver #1,” “receiver #2”). The wireless workbench application may interface with the frequency coordination server(s) 115 to access the user's account information, including the user's historical audio device data (e.g., previously entered audio devices 120 and/or previous spectrum information, such as one or more previously used frequencies). Although establishing a user account provides several advantages (e.g., maintain the user's historical audio device data), a user account and/or user registration may not be required, and the user 402 may access the spectrum coordination system anonymously and/or as a temporary, unregistered user. For example, the user 402 may engage the poster 404 at the venue and access the spectrum coordination system as a temporary and/or anonymous user by interfacing with the computer-readable code(s), label(s), tag(s), link(s), etc. provided on the poster 404. Because the poster 404 (and its included code(s), label(s), tag(s), link(s), etc.) may be specific to the venue, access to the spectrum coordination system and the venue-specific spectrum coordination can be limited to those users 402 at the venue regardless of whether the user 402 is known (e.g., via authentication of the user 402 using their registered user account) to the spectrum coordination system. Security of the spectrum coordination system can be further ensured by limiting access to the poster 404 to only those users 402 that have passed through the venue's security (e.g., locating the poster 404 within the venue so that it is only accessible to those users 402 that have been granted access to the venue).

As shown in FIG. 4C, the RF spectrum coordination interface may be a website providing a cloud-based wireless workbench application that provides a notification 420 for the user to download and install wireless workbench mobile application by clicking on the download button 422 generated by the GUI of the user device 120. If the user device 102 includes an installation of a wireless workbench mobile application (e.g., FIG. 7), the scanning of the QR code 406 will cause the user device 120 to launch the wireless workbench mobile application (e.g., instead of launching the browser), which may include an interface similar to that of the cloud-based wireless workbench application.

The RF spectrum coordination interface may include the location 424 (e.g., “Carol's Pub”) associated with the QR code 406, as well as provide the ability for the user 402 to change the location by selecting the “change location” element 426. In this example, the location 424 may be pre-populated based on an association with the QR code 406 scanned by the user device 120. The wireless workbench application may provide the audio device(s) 428, 430 associated with the user 402 (e.g., “receiver #1,” “receiver #2”), as well as allow the user 402 to add one or more other audio devices by selecting the “add another wireless device” element 432. The user 402 may also remove one or more audio devices by clicking on the corresponding “X” element. The audio device(s) associated with the user may be based on the user's historical audio device information, which may include the audio devices 105 that have been previously provided by the user 402 (e.g., previously entered in the wireless workbench application).

The wireless workbench application may provide the available RF spectrum at the location 424. For example, the wireless workbench application may interface with the frequency coordination server(s) 115 to obtain information associated with the user 402, such as the user's historical audio device information. The wireless workbench application may provide a listing of the user's audio devices 428, 430 that have been previously entered in the wireless workbench application. Based on RF spectrum information for the location (e.g., other user(s) at the location 424, their (and/or other) audio devices, the RF frequency spectrum used by the other audio device(s), and/or other wireless communication devices/systems) and the RF spectrum information associated with user 402, the frequency coordination server(s) 115 may determine frequency coordination information for the location, and perform frequency coordination (based on the determined frequency coordination information) to coordinate the RF spectrum at the location 424. Additionally, or alternatively, the RF spectrum information may include previously established coordination information for the location, including spectrum scans, existing wireless audio devices and equipment, local television stations, and/or other information and/or parameters that may impact the wireless performance of the audio systems.

Turning to FIG. 4D, to access the frequency coordination information for the location 424 (e.g., the available and compatible frequencies), the user 402 may select the “show [# of channels] compatible frequencies” element 434. Based on this selection, the wireless workbench application may provide the available RF frequencies 429, 431 for the “receiver #1” device 480 and “receiver #2” device 430, respectively. The wireless workbench application may also allow the user 402 to share the available frequencies with one or more one or more other user's by selecting the respective “share” element 440, 441 for the user's audio devices 428, 430.

In this example, the available and compatible frequencies may be determined and provided based on the frequency coordination information, location data (e.g., which may be used to determine local over-the-air (OTA) television and/or radio channels and/or frequencies), the respective models and/or frequency bands associated with the user device(s) 120 and/or audio device(s) 105, and/or frequency scan data. The frequency scan data may include frequency scan information for the venue that was previously uploaded to the frequency coordination server(s) 115 or otherwise provided thereto, and/or other scan data that is a closet match to the venue's location.

Via the wireless workbench application, the user 402 may also checkout one or more available and compatible RF frequencies. For example, the user 402 may select the “checkout” element 442 to facilitate the checkout of the RF frequencies. In the illustrated example, the available RF frequencies 429, 431 for the “receiver #1” device 480 and “receiver #2” device 430, respectively, may be checked out by the user 402 upon the activation of the “checkout” element 442. The checking out of one or more frequencies may include the reservation of RF spectrum (e.g., one or more frequencies and/or frequency ranges) for use by user 402 and its one or more audio devices 105. The reservation of RF spectrum may be associated with temporal information (e.g., time duration, date), one or more locations, and/or other parameter(s) so that the listed frequencies are reserved by the user 402 for a predetermined or selected time period (e.g., 24 hours) for the particular location. FIG. 4E shows the wireless workbench application including the checked out (reserved) RF spectrum 429, 431 for the “receiver #1” device 480 and “receiver #2” device 430, respectively, that has been reserved by the user 402. A record of the checked out (reserved) RF spectrum may be stored by the user device 120 and/or the frequency coordination server(s) 115 as frequency coordination information, and/or be used for frequency coordination for one or more other audio devices at the location. The stored recorded may be accessed by the wireless workbench application using, for example, a unique Uniform Resource Locator (URL) or another locator or identifier.

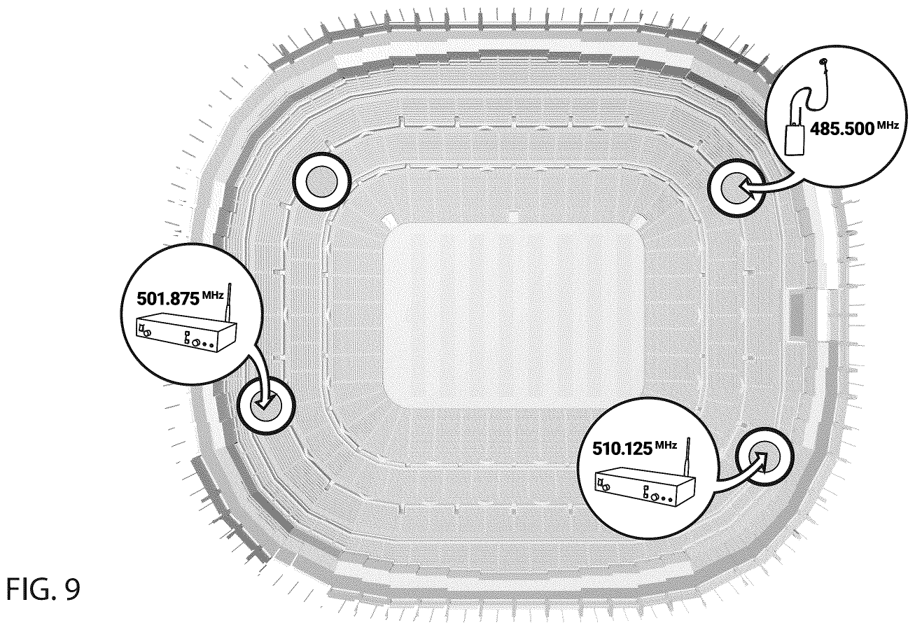

Advantageously, after the RF spectrum has been reserved (and the corresponding frequency coordination information has been generated) using, for example, the frequency coordination cloud-based service of the frequency coordination server(s) 115, internet access is no longer required to perform frequency coordination, and the user 402 may deploy frequencies to their audio device(s) 105 in an offline process, such as via a private network (e.g., wireless PAN 225 in FIG. 2) or by manual entry on an I/O interface of the audio device(s) 105. If additional users perform the method for radio frequency coordination as discussed with reference to FIGS. 4A-4E at the same location, the wireless workbench application may notify the other user(s) about other user(s) (e.g., user 402), and perform frequency coordination to improve performance and reduce the likelihood of interference between the various users at the location. The frequency coordination aspects as illustrated with respect to FIGS. 4A-4E are also applicable for use in large venues (e.g., stadium environments) as illustrated in FIG. 9.

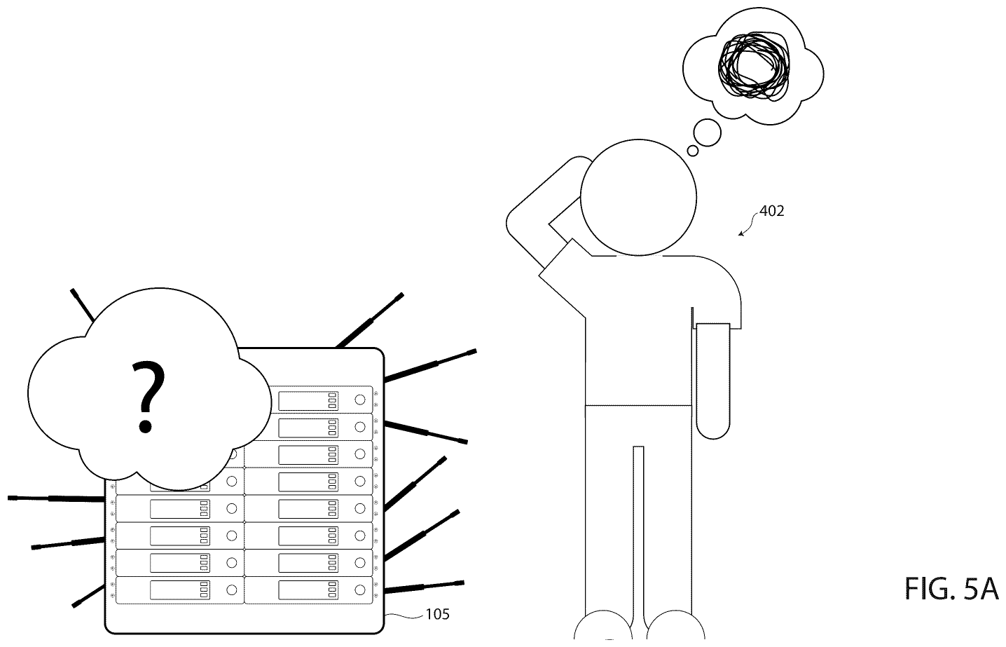

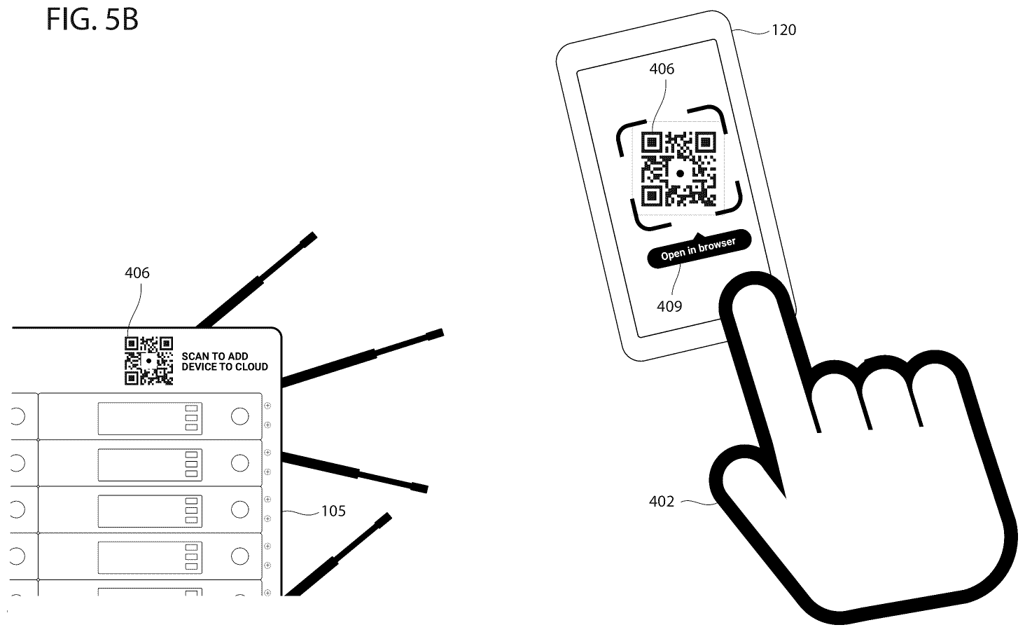

FIGS. 5A-5B illustrate a workflow of a method for radio frequency coordination according to one or more aspects of the disclosure. The workflow of FIGS. 5A-5B is similar to the workflow of FIGS. 4A-4B, but includes the QR being located on an audio device (e.g., of the venue) in which the user's audio devices are to interface with. After the operations illustrated in FIG. 5B, the workflow can include the operations as illustrated in FIGS. 4C-4E.

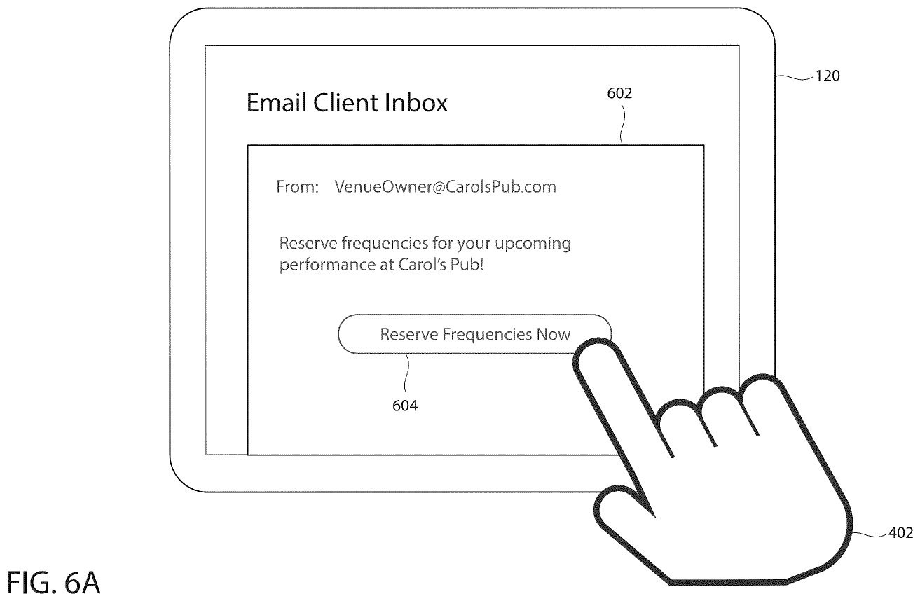

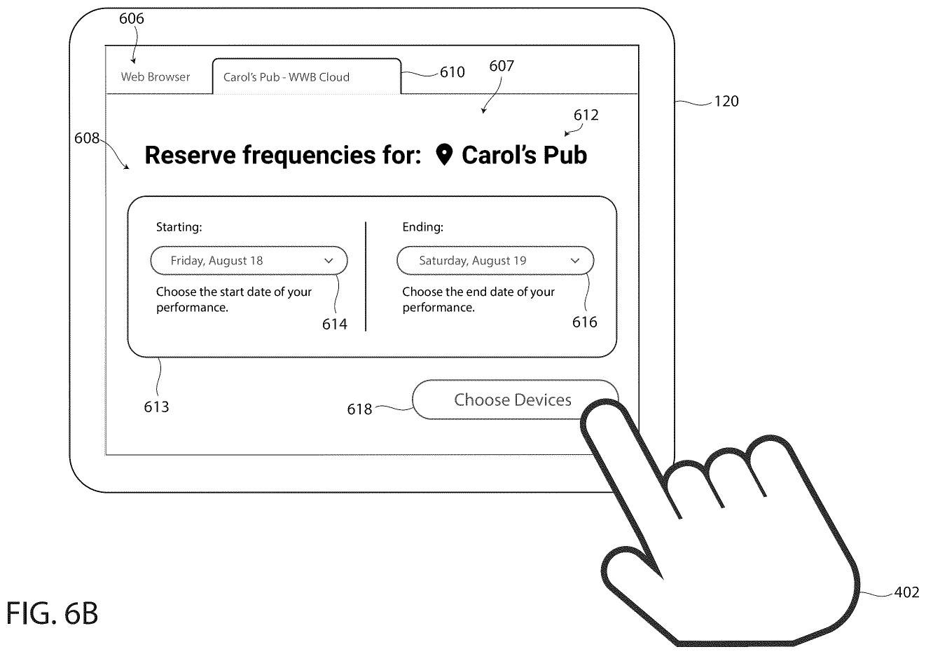

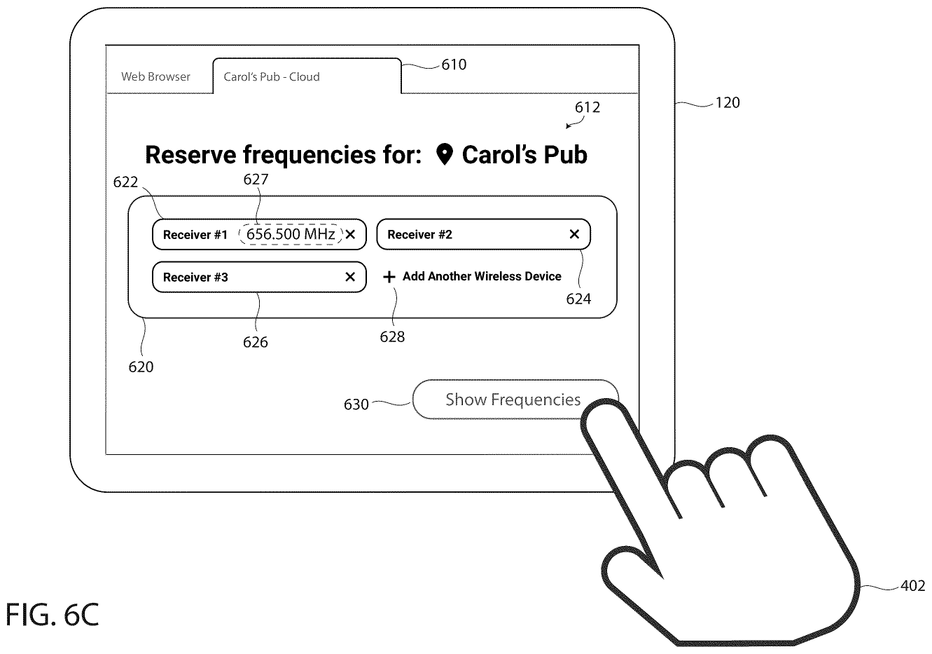

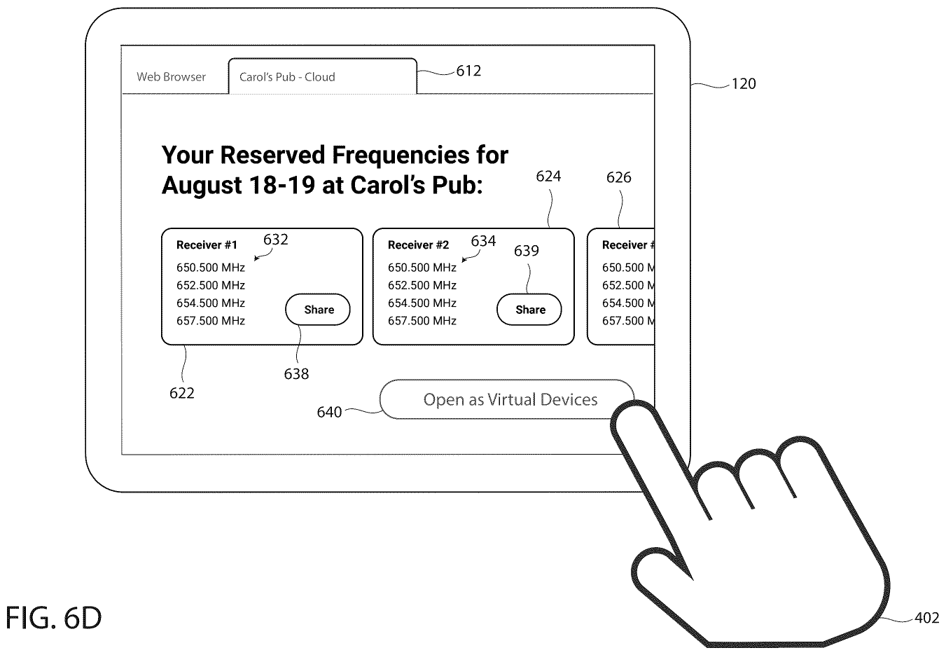

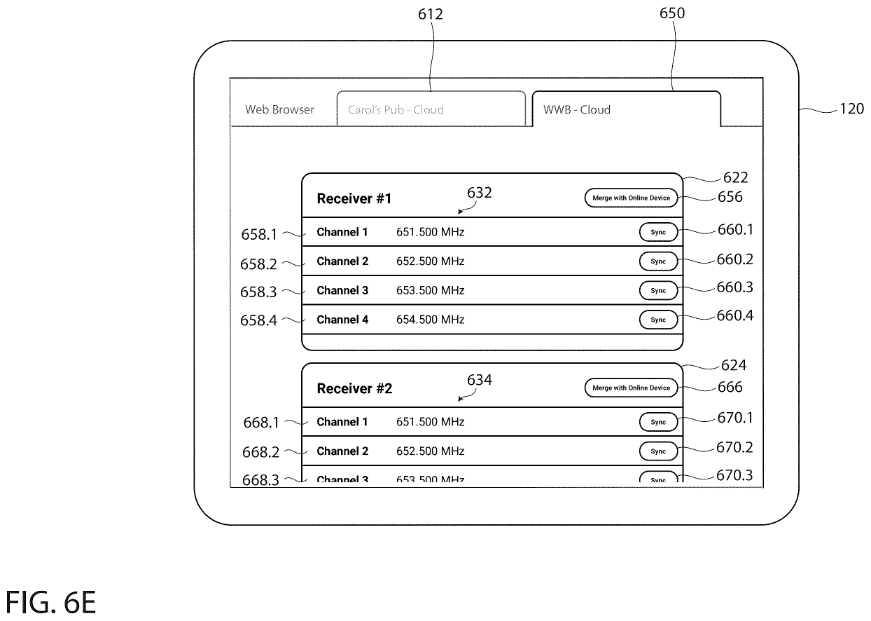

FIGS. 6A-6E illustrate a workflow of a method for radio frequency coordination according to one or more aspects of the disclosure. The workflow is similar to the workflow of FIGS. 4A-4E, but includes the access to available RF spectrum being initiated based on an email or weblink provided by the corresponding venue. This method can be used to identify and reserve available and compatible RF spectrum in advance. This method is even more advantageous in the event that internet access at the location/venue is unavailable or limited. In such a situation, the user 402 may reserve the available and compatible RF spectrum using the wireless workbench application to access the cloud-based service of the frequency coordination server(s) 115. The user 402 may then configure their audio device(s) 105 by connecting the audio device(s) 105 to the same network while at a location with internet access, or in an offline process using a private network with the user device 120 (e.g., using wireless PAN 225 in FIG. 2) or by manual entering the frequencies on an I/O interface of the audio device(s) 105. The offline configuration may be performed in advance of arriving at the venue, or upon arrival.

FIG. 6A shows the receipt of an email 602 by user 402 on their user device 120. The email 602 may be from the venue (e.g., “Carol's Pub,” location 612) and/or a party associated with RF spectrum coordination for the venue. The email may be sent to the user 402 to facilitate the coordination of the RF spectrum available at the venue.

The email 602 may include a request for the user 402 to reserve frequencies for one or more future times and/or dates at the venue. The email 602 may include a link 604 (e.g., “Reserve Frequencies Now”) that is selectable by the user 402 to obtain further information to assist in the radio frequency coordination. The Link 604 may be a universal resource locators (URL). As shown with reference to FIG. 6B, the selection of the link 604 may launch (e.g., based on the instruction(s) embedded in the link 604, such as a hyperlink) a wireless workbench mobile application installed on the user device 120 or initiate the installation of the wireless workbench application (e.g., from the server(s) 115) if not yet installed. Additionally, or alternatively, the selection of the link 604 may launch a web browsing application on the user 120 and direct the web browsing application to a cloud-based wireless workbench application interface. The cloud-based wireless workbench application may be hosted by the frequency coordination server(s) 115, which may communicate with the wireless workbench application to exchange frequency coordination information with the user 402.

FIG. 6B shows a cloud-based wireless workbench application 607 that has been launched in a tab 610 of web browsing application 606 on the user device 120. The cloud-based wireless workbench application 607 provides a cloud-based wireless workbench interface 608 that is associated with the venue/location 612. The interface 608 may include an element 613 configured to allow for the selection of a times and/or dates for a requested reservation of RF spectrum at the location 612. The element 613 may include a selectable start time and/or date 614 (e.g., drop down menu) and a selected end time and/or date 616 (e.g., drop down menu). Additionally, or alternatively, the element 613 may include a selectable start time and/or date, and a selectable duration. Once the time and/or date period has been selected, the period may be submitted to the host of the wireless workbench application (e.g., the frequency coordination server(s) 115) by selecting “choose devices” element 618.

Turning to FIG. 6C, following (e.g., in response to) the selection of element 613, the cloud-based wireless workbench interface 608 may provide one or more the audio device(s) 620 associated with the user 402 (e.g., in the user's account of the wireless workbench) that have previously added and associated with the user 402. The audio device(s) associated with the user may be based on the user's historical audio device information, which may include the audio devices 105 that have been previously provided by the user 402 (e.g., previously entered in the wireless workbench application). The wireless workbench application may interface with the frequency coordination server(s) 115 to obtain information associated with the user, such as the user's historical audio device information.

In this example, the cloud-based wireless workbench interface 608 may provide devices 620, 622, 624 (e.g., “Receiver #1,” “Receiver #2,” “Receiver #3,”), as well as allow the user 402 to add one or more other audio devices by selecting the “add another wireless device” element 628. The user 402 may also remove one or more audio devices by clicking on the corresponding “X” element. To access the frequency coordination information for the location 612 (e.g., the available and compatible frequencies), the user 402 may select the “show frequencies” element 630. The cloud-based wireless workbench interface 608 may allow the user 402 to request one or more frequencies 627 when adding one or more audio devices. For example, the user 402 could add a desired frequency, such as the frequency currently in use on the device being added. This advantageously allows for the frequency coordination to preserve those frequencies presently configured on the added device if the frequencies are available for use. This would reduce the need to reconfigure the spectrum settings on the added device(s) unless the desired frequencies are deemed unavailable by the coordination system. For example, if the frequencies are not available (e.g., someone else is presumably using them or they are reserved for other uses at the venue (e.g., occupied by TV or restricted channels), then a new frequency can be provided by the wireless workbench application.

As shown in FIG. 6D, based on this selection, the cloud-based wireless workbench interface 608 may provide the available RF spectrum (e.g., one or more frequencies or frequency ranges) for the location 612 during the specified data and/or time period. The cloud-based wireless workbench interface 608 may provide the available RF frequencies 632, 634 for the audio devices 622, 624, 626. The cloud-based wireless workbench interface 608 may also allow the user 402 to share the available frequencies with one or more one or more other user's by selecting the respective “share” element 638, 639 for the user's audio devices.

The frequency coordination server(s) 115 may determine frequency coordination information for the location 612 based on RF spectrum information for the location 612 (e.g., other user(s) at the location 612, their (and/or other) audio devices, the RF frequency spectrum used by the other audio device(s), and/or other wireless communication devices/systems) and the RF spectrum information associated with user 402. The frequency coordination server(s) 115 may perform frequency coordination (based on the determined frequency coordination information) to coordinate the RF spectrum at the location 612. Additionally, or alternatively, the RF spectrum information may include previously established coordination information for the location, including spectrum scans, existing wireless audio devices and equipment, local television stations, and/or other information and/or parameters that may impact the wireless performance of the audio systems. In this example, the available and compatible frequencies may be determined and provided based on the frequency coordination information, location data (e.g., which may be used to determine local over-the-air (OTA) television and/or radio channels and/or frequencies), the respective models and/or frequency bands associated with the user device(s) 120 and/or audio device(s) 105, and/or frequency scan data. The frequency scan data may include frequency scan information for the venue that was previously uploaded to the frequency coordination server(s) 115 or otherwise provided thereto, and/or other scan data that is a closet match to the venue's location.

As is illustrated in FIG. 6D, the user 402 may reserve (e.g., checkout), via the cloud-based wireless workbench interface 608, one or more available and compatible RF frequencies by selecting the “open as virtual devices” element 640. The reservation of RF spectrum may be associated with temporal information (e.g., time duration, date), one or more locations, and/or other parameter(s) so that the listed frequencies are reserved by the user 402 for a predetermined or selected time period (e.g., 24 hours) for the particular location. The reserved RF spectrum may be manually deployed to the user's devices by manual entry on an I/O interface of the audio device(s) 105 using the record of the reserved RF spectrum.

Turning to FIG. 6E, the user 402 may assign frequencies to one or more of their audio devices 622, 624, 626. The cloud-based wireless workbench interface 608 may control the web browsing application to open another browser tab (or browser window) 650 associated with the user's wireless workbench and list their audio devices 622, 624, 626 and the reserved RF spectrum. For example, for audio device 622, the cloud-based wireless workbench interface 608 may associate the RF frequencies 632 to one or more respective channels 658. Similarly, for audio device 624, the cloud-based wireless workbench interface 608 may associate the RF frequencies 634 to one or more respective channels 668.

The cloud-based wireless workbench interface 608 may be adapted to facilitate the synchronization of the frequencies 632, 634 to the audio devices 622, 624, 626 to configure the audio devices 622, 624, 626 to operate using the reserved frequencies for the respective channels. For example, the user 402 may select the respective “sync” element 660, 670 for the audio devices 622, 624, 626. In this example, the audio device 636 is provide below the audio device 624 in the tab 650, and is accessible by scrolling down in the tab 650. Additionally, or alternatively, the cloud-based wireless workbench interface 608 may be configured to collectively synchronize all channels with respective frequencies instead of separate synchronization operations for each of the channels 658, 668. For example, the user 402 may select the “merge with online device” element 656, 666 for the respective audio devices 622, 624 to synchronize all channels and associated frequencies for the respective audio device to configure the audio devices 622, 624, 626 to operate using the reserved frequencies for the respective channels. A record of the reserved RF spectrum may be stored by the user device 120 and/or the frequency coordination server(s) 115 as frequency coordination information, and/or be used for frequency coordination for one or more other audio devices at the location.

Advantageously, after the RF spectrum has been reserved (and the corresponding frequency coordination information has been generated) and synchronized using, for example, the frequency coordination cloud-based service of the frequency coordination server(s) 115, internet access may no longer be required for configuration of the audio device(s) 105. For example, in an aspect where the frequencies are not synchronized to configure the audio devices during the reservation operation, the configuration of the audio devices may be performed at a later time by deploying frequencies to the audio device(s) 105 in an offline process, such as via a private network (e.g., wireless PAN 225 in FIG. 2) or by manual entry on an I/O interface of the audio device(s) 105 using the record of the reserved RF spectrum. If the internet is available at the later time, the synchronization and configuration may be performed as discussed above by selecting the elements 660, 670 and/or elements 656, 666.

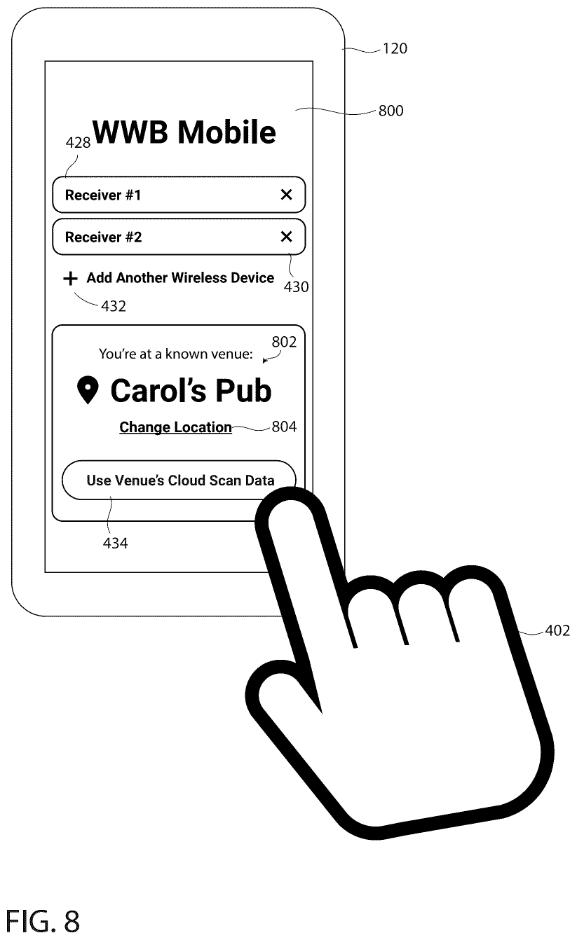

FIG. 8 illustrates a wireless workbench mobile application 800 that has been installed on the user device 120. In this example, the wireless workbench mobile application may be launched automatically on the user device 120 based on location services of the user device 120. In particular, the location services of the user device 120 may determine that the location of the user device 120, and provide the location to the frequency coordination server(s) 115, which may be configured to compare the location of the user device 120 to one or more locations stored in database of (or associated with) the frequency coordination server(s) 115. If the frequency coordination server(s) 115 determines, based on the comparison, that the user device 120 is located at a location that is associated with a known venue/location 802 (e.g., a location known to the frequency coordination service of the frequency coordination server(s) 115), the frequency coordination server(s) 115 may provide a control command to the wireless workbench mobile application to launch on the user device 120 and notify the user 402. Alternatively (or additionally), the control command from the frequency coordination server(s) 115 may cause the wireless workbench mobile application to generate a notification on the user device 120. The wireless workbench mobile application may then be launched in response to a selection of the notification by the user. The known venue/location 802 that has been determined may be changed by selection of the “change location” element 804. Additionally, or alternatively, the user device 120 may store one or more locations known to the frequency coordination service, and the wireless workbench mobile application installed on the user device 120 may determine when the user device 120 is at a known venue/location 802 by comparing the current location of the user device 120 (e.g., using its location service) with the stored known location(s). If the wireless workbench mobile application determines that the user device 120 is at a known venue/location 802, the wireless workbench mobile application may automatically launch on the user device 120 and notify the user 402. Alternatively (or additionally), the wireless workbench mobile application may generate a notification on the user device 120 notifying the user to facilitate RF spectrum coordination.

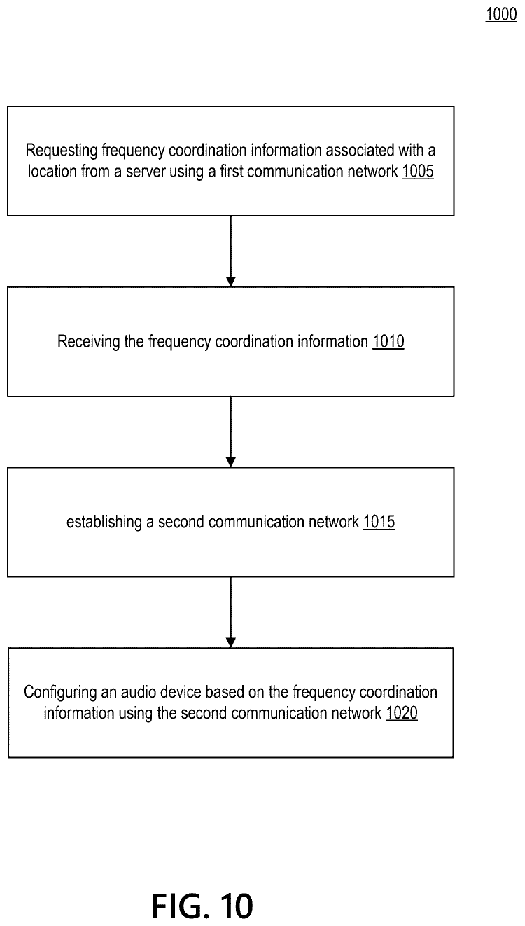

FIG. 10 shows an example method 1000 for radio frequency coordination. The example method may be performed by one or more computing devices 300, such as audio device(s) 105, server(s) 115, and/or user device(s) 120. Two or more of the various operations of the method 1000 may be performed simultaneously in one or more aspects. Further, the order of the various operations is not limiting and the operations may be performed in a different order in one or more aspects.

At step 1005, frequency coordination information associated with a location is requested (e.g., from server 115). The computing device 300 (e.g., user device 120) may request the frequency coordination information from the server 115. The requesting of the frequency coordination information may include scanning or otherwise reading a machine-readable code (e.g. QR code) by the computing device 300. Communications between the computing device 300 and the server may use a first communication network, such as network 125.

At step 1010, the frequency coordination information may be received from the server 115 by the computing device 300. The frequency coordination information may be received using the first communication network (e.g., network 125).

At step 1015, a second communication network (e.g., PAN 225) is established. The second communication network may be established by the computing device 300 to facilitate communication with one or more audio devices 105.

At step 1020, the audio device(s) 105 are configured based on the frequency coordination information by the computing device 300. The computing device 300 can provide the frequency coordination information to the audio device(s) 105 using the second communication network.

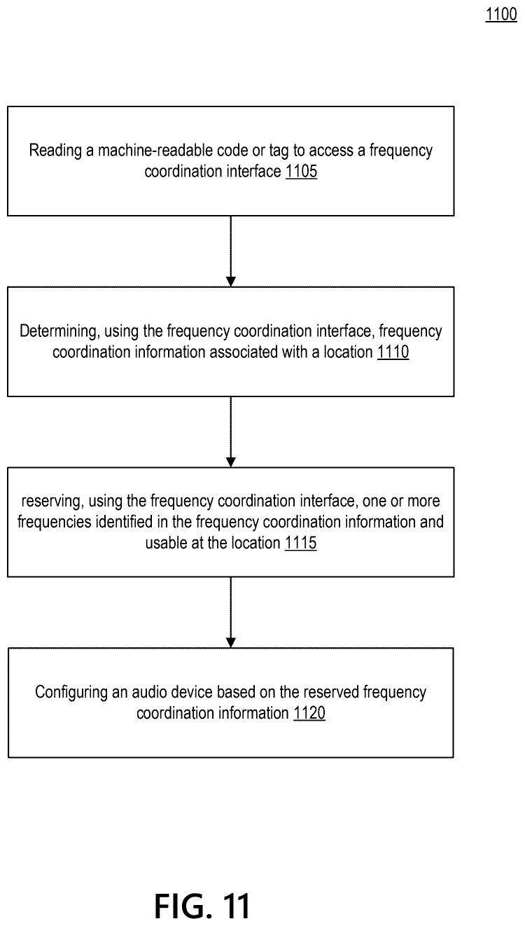

FIG. 11 shows an example method 1100 for radio frequency coordination. The example method may be performed by one or more computing devices 300, such as audio device(s) 105, server(s) 115, and/or user device(s) 120. Two or more of the various operations of the method 1000 may be performed simultaneously in one or more aspects. Further, the order of the various operations is not limiting and the operations may be performed in a different order in one or more aspects.

At step 1105, a machine-readable code or tag is read to access a frequency coordination interface. For example, the computing device 300 (e.g., user device 120) may read a QR code (e.g. using its camera) and/or read a wireless tag (e.g., using its transceiver), and/or access a hyperlink, to access a frequency coordination interface. The scanning of the code/tag may cause a browser to launch an associated website or open an application on the computing device 300.

At step 1110, frequency coordination information associated with a location is determined. The frequency coordination interface can facilitate the determination of the frequency coordination information by interfacing with the server 115. The machine readable code maybe located at the location.

At step 1115, one or more frequencies identified in the frequency coordination information and usable at the location may be reserved (e.g., by the user). Reserving the frequencies may be made using the frequency coordination interface, and the frequencies may be reserved for a particular date and/or time for use at the location.

At step 1120, the audio device(s) 105 are configured based on the reserved frequencies. The frequencies can be manually entered into an interface of the audio device(s) 105 and/or configuration data (including the frequencies, channels, and/or other parameters) can be transmitted to the audio device(s) 105 by the user device 120 and/or server 115.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

Hereinafter, various characteristics will be highlighted in a set of numbered clauses or paragraphs. These characteristics are not to be interpreted as being limiting on the invention or inventive concept, but are provided merely as a highlighting of some characteristics as described herein, without suggesting a particular order of importance or relevancy of such characteristics.

Clause 1. A frequency coordination method, comprising: requesting, by a computing device and using a first communication network, frequency coordination information associated with a location from a server; receiving, by the computing device and from the server using the first communication network, the frequency coordination information; establishing, by the computing device, a second communication network; and configuring, by the computing device and using the second communication network, an audio device based on the frequency coordination information.

Clause 2. The method of clause 1, wherein the frequency coordination information comprises available radio frequency spectrum at the location.

Clause 3. The method of clause 1, wherein the requesting the frequency coordination information comprises providing a time period to the server, the frequency coordination information including available radio frequency spectrum at the location during the time period.

Clause 4. The method of clause 1, wherein requesting the frequency coordination information comprises scanning a machine-readable code to generate a request for the frequency coordination information; and sending the request to the server using the first communication network.

Clause 5. The method of clause 4, wherein the machine-readable code is a quick-response (QR) code.

Clause 6. The method of clause 1, wherein requesting the frequency coordination information comprises wirelessly communicating with a wireless tag to generate a request for the frequency coordination information; and sending the request to the server using the first communication network.

Clause 7. The method of clause 1, wherein requesting the frequency coordination information comprises selecting a hyperlink to generate a request for the frequency coordination information; and sending the request to the server using the first communication network.

Clause 8. The method of any of clauses 4-7, wherein the request identifies the location and a time period for the location, the frequency coordination information being determined based on the identified location and the time period.

Clause 9. The method of clause 8, wherein the frequency coordination information is further determined based on one or more other audio devices anticipated to be at the location during the time period.

Clause 10. The method of any of clauses 1-9, wherein configuring the audio device based on the frequency coordination information comprises configuring the audio device to operate using one or more frequencies included in the available radio frequency spectrum.

Clause 11. The method of clause 1, wherein requesting the frequency coordination information comprises detecting, by the computing device, a current location of the computing device and automatically requesting the frequency coordination information based on the detection of the current location.

Clause 12. The method of any of clauses 1-11, wherein the first communication network is unavailable during the configuration of the audio device

Clause 13. The method of any of clauses 1-12, wherein the second communication network is personal area network.

Clause 14. The method of any of clauses 1-13, wherein the first communication network uses a first communication protocol and the second communication network uses a second communication protocol different from the first communication protocol.

Clause 15. The method of any of clauses 1-14, wherein the first communication network has internet access and the second communication network lacks internet access.

Clause 16. A computer-readable medium storing instructions that, when executed, cause one or more processors to perform the method of any one of clauses 1-15.

Clause 17. A computing device comprising one or more processors and memory storing instructions that, when executed by the one or more processors, cause the computing device to perform the method of any one of clauses 1-15.

Clause 18. A computing device, comprising: one or more processors; and memory storing instructions that, when executed by the one or more processors, cause the computing device to: request, from another computing device using a first communication network, frequency coordination information associated with a location; receive, from the other computing device using the first communication network, the frequency coordination information; establish a second communication network; and configure, using the second communication network, an audio device based on the frequency coordination information.

Clause 19. The computing device of clause 18, further comprising a transceiver configured to communicate using the first and the second communication networks.

Clause 20. The computing device of any of clauses 18-19, wherein the frequency coordination information comprises available radio frequency spectrum at the location.

Clause 21. The computing device of any of clauses 18-20, wherein requesting the frequency coordination information comprises providing a time period to the other computing device, the frequency coordination information including the available radio frequency spectrum at the location during the time period.

Clause 22. The computing device of any of clauses 18-21, wherein requesting the frequency coordination information comprises scanning a machine-readable code to generate a request for the frequency coordination information; and transmitting the request to the other computer device using the first communication network.

Clause 23. The computing device of clause 22, wherein the machine-readable code is a quick-response (QR) code.

Clause 24. The computing device of any of clauses 18-21, wherein requesting the frequency coordination information comprises wirelessly communicating with a wireless tag to generate a request for the frequency coordination information; and transmitting the request to the other computing device using the first communication network.

Clause 25. The computing device of any of clauses 18-21, wherein requesting the frequency coordination information comprises selecting a hyperlink to generate a request for the frequency coordination information; and transmitting the request to the other computing device using the first communication network.

Clause 26. The computing device of any of clauses 21-25, wherein the request identifies the location and a time period for the location, the frequency coordination information being determined based on the identified location and the time period.

Clause 27. The computing device of clause 26, wherein the instructions, when executed by the one or more processors, cause the computing device to determine the frequency coordination information further based on one or more other audio devices anticipated to be at the location during the time period.

Clause 28. The computing device of any of clauses 18-27, wherein configuring the audio device based on the frequency coordination information comprises configuring the audio device to operate using radio frequency spectrum identified in the frequency coordination information.

Clause 29. A frequency coordination method, comprising: reading, by a computing device, a machine-readable code or tag to access a frequency coordination interface; determining, by the computing device and using the frequency coordination interface, frequency coordination information associated with a location; and reserving, by the computing device and using the frequency coordination interface, one or more frequencies identified in the frequency coordination information and usable at the location.

Clause 30. The method of clause 29, further comprising configuring, by the computing device, one or more audio devices to use the reserved one or more frequencies.

Clause 31. The method of any of clauses 29-30, wherein the frequency coordination interface is accessed using a communication network that is unavailable during the configuration of the one or more audio devices.

Clause 32. The method of any of clauses 29-31, wherein the frequency coordination interface is accessed using a communication network, the configuration of the one or more audio devices being independent of the communication network.

Clause 33. The method of any of clauses 29-32, wherein the frequency coordination interface is accessed using a first communication network, the configuration of the one or more audio devices using a second communication network different from the first communication network.

Clause 34. The method of any of clauses 29-33, wherein the machine-readable code or tag is a quick-response (QR) code.

Clause 35. The method of any of clauses 29-33, wherein the machine-readable code or tag is a wireless tag.

Clause 36. The method of clause 35, wherein the wireless tag is a near-field communication (NFC) tag, Bluetooth tag, or radio-frequency identification (RFID) tag.

Clause 37. A computer-readable medium storing instructions that, when executed, cause performance of the method any one of clauses 29-36.

Clause 38. A computing device comprising one or more processors and memory storing instructions that, when executed by the one or more processors, cause the computing device to perform the method of any one of clauses 29-36.

1. A frequency coordination method, comprising:
requesting, by a computing device and using a first communication network, frequency coordination information associated with a location from a server;
receiving, by the computing device and from the server using the first communication network, the frequency coordination information;
establishing, by the computing device, a second communication network; and
configuring, by the computing device and using the second communication network, an audio device based on the frequency coordination information.

2. The method of claim 1, wherein the frequency coordination information comprises available radio frequency spectrum at the location.

3. The method of claim 1, wherein the requesting the frequency coordination information comprises providing a time period to the server, the frequency coordination information including available radio frequency spectrum at the location during the time period.

4. The method of claim 1, wherein requesting the frequency coordination information comprises scanning a machine-readable code to generate a request for the frequency coordination information; and sending the request to the server using the first communication network.

5. The method of claim 4, wherein the machine-readable code is a quick-response (QR) code.

6. The method of claim 1, wherein requesting the frequency coordination information comprises wirelessly communicating with a wireless tag to generate a request for the frequency coordination information; and sending the request to the server using the first communication network.

7. The method of claim 1, wherein requesting the frequency coordination information comprises selecting a hyperlink to generate a request for the frequency coordination information; and sending the request to the server using the first communication network.

8. The method of claim 4, wherein the request identifies the location and a time period for the location, the frequency coordination information being determined based on the identified location and the time period.

9. The method of claim 8, wherein the frequency coordination information is further determined based on one or more other audio devices anticipated to be at the location during the time period.

10. The method of claim 1, wherein configuring the audio device based on the frequency coordination information comprises configuring the audio device to operate using one or more frequencies included in the frequency coordination information.

11. The method of claim 1, wherein requesting the frequency coordination information comprises detecting, by the computing device, a current location of the computing device and automatically requesting the frequency coordination information based on the detection of the current location.

12. The method of claim 1, wherein the first communication network uses a first communication protocol and the second communication network uses a second communication protocol different from the first communication protocol.

13. A non-transitory computer-readable medium storing instructions that, when executed, cause one or more processors to perform the method of claim 1.

14. A computing device, comprising:
one or more processors; and
memory storing instructions that, when executed by the one or more processors, cause the computing device to:
request, from another computing device using a first communication network, frequency coordination information associated with a location;
receive, from the other computing device using the first communication network, the frequency coordination information;
establish a second communication network; and
configure, using the second communication network, an audio device based on the frequency coordination information.

15. The computing device of claim 14, further comprising a transceiver configured to communicate using the first and the second communication networks.

16. The computing device of claim 14, wherein the frequency coordination information comprises available radio frequency spectrum at the location.

17. The computing device of claim 14, wherein requesting the frequency coordination information comprises providing a time period to the other computing device, the frequency coordination information including available radio frequency spectrum at the location during the time period.

18. The computing device of claim 14, wherein requesting the frequency coordination information comprises reading a machine-readable code to generate a request for the frequency coordination information; and transmitting the request to the other computer device using the first communication network.

19. The computing device of claim 18, wherein the machine-readable code is a quick-response (QR) code.

20. The computing device of claim 14, wherein requesting the frequency coordination information comprises wirelessly communicating with a wireless tag to generate a request for the frequency coordination information; and transmitting the request to the other computing device using the first communication network.
